(19) United States
(12) Patent Application Publication
(10) Pub. No.: US 2008/0025902 A1
(43) Pub. Date: Jan. 31, 2008

(54) Method To Synthesize Highly Luminescent Doped Metal Nitride Powders

(75) Inventors: Fernando A. Ponce, Tempe, AZ (US); Rafael Garcia, Tempe, AZ (US); Alan C. Thomas, Gilbert, AZ (US); Abigail Bell, Northants (GB)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Arizona Board of Regents, a body corpate acting on behalf of Arizona State University

(21) Appl. No.: 10/589,541

(22) PCT Filed: Apr. 27, 2005
(86) PCT No.: PCT/US05/14514

§ 371 Date: May 1, 2007

Related U.S. Application Data
(60) Provisional application No. 60/566,147, filed on Apr. 27, 2004.
(60) Provisional application No. 60/566,148, filed on Apr. 27, 2004.

(51) Int. Cl. C09K 11/08

(52) U.S. Cl. 423/409; 75/363

(57) ABSTRACT

A simple, inexpensive method of producing in bulk a doped metal nitride powder that exhibits a high luminescent efficiency, by first forming a metal-dopant alloy and then reacting the alloy with high purity ammonia under controlled conditions in a reactor. The resulting doped metal nitride powders will exhibit a luminescent efficiency that greatly exceeds that seen in pure undoped GaN powders, doped GaN thin films, and ZnS powders.

### CROSS REFERENCE TO RELATED APPLICATIONS

This application claims priority from (1) U.S. provisional application Ser. No. 60/566,147, entitled “Method to Synthesize Highly Luminescent Magnesium Doped Gallium Nitride Powders,” and (2) U.S. provisional application Ser. No. 60/566,148, entitled “Method to Synthesize Highly Luminescent Silicon-Doped Gallium Nitride Powders,” both of which were filed on Apr. 27, 2004. These applications are incorporated herein by reference.

### BACKGROUND

In the last few decades, there has been a quest for new semiconductor materials for use in new generation electroluminescent (EL) devices. EL devices include light emitting diodes (LEDs) and electroluminescent displays (ELDs), which are devices that can be used to display text, graphics and images on computer and television screens, and can be used in lamps and backlights. Specific examples include EL lamps, backlight LCDs, watch lights, cell phones, gauges, ultra-thin flat panel displays, EL wires and EL panels. Metal nitrides exhibit some unique properties that make them ideal semiconductor materials for use in these devices, including a large direct band gap, strong interatomic bonds, and high thermal conductivity. It is also recognized that the introduction of suitable dopants such as magnesium (Mg), silicon (Si), and rare earths (Pr, Eu, Er, Tm) and the formation of solid solutions with indium nitride (InN) allow the full range of visible electromagnetic radiation (from 400 to 700 nm) to be obtained. Magnesium is generally recognized in the art as an acceptor impurity of choice for doping p-type semiconductor materials, and silicon is generally recognized in the art as a donor impurity of choice for doping n-type semiconductor materials.

Until now research in the EL lighting industry has focused primarily on GaN thin films and zinc sulfide (ZnS) powders. GaN powders and other metal nitride powders have been largely overlooked despite having a huge potential for impact in the EL lighting industry. Current GaN thin film and ZnS powder devices are not improving in efficiency and luminescent quality as fast as technology demands, so it has become necessary to look to other semiconductor materials as alternatives. Research indicates that GaN and other metal nitride powders may be used as alternative semiconductor materials that if produced properly will lead to improved luminescence. These results have been explained and documented in U.S. utility patent application Ser. No. 10/997,254, entitled “Improved Systems and Methods for Synthesis of Gallium Nitride Powders,” which is herein incorporated by reference. However, an important step towards using GaN and other metal nitride powders as improved semiconductor alternatives in EL devices is to be able to achieve controlled n-type and p-type doping in the powder. There is a further need to synthesize doped metal nitride powders that exhibit the full range of visible electromagnetic radiation, from red to violet.

### SUMMARY OF THE INVENTION

The present invention relates to a process for synthesizing, in bulk, highly luminescent doped metal nitride powders that exhibit visible electromagnetic radiation and possess improved luminescent properties. The metal nitrides in this invention refer to the group III nitride semiconductors (GaN, InN, AlN), their ternary alloys (AlGaN, InGaN, and AlInN), and their quaternary alloys (AlGaInN). Because of ease of production, GaN is currently the most commonly used and basic material among the metal nitride system. Another object of the present invention is to provide a simple, inexpensive process that allows bulk production of superior phosphor materials. The process according to the preferred embodiment involves reacting a metal-dopant alloy with high purity ammonia in a reactor at an elevated temperature for some suitable amount of time.

The process of the present invention is not limited to the introduction of any specific dopant. Those skilled in the art will recognize that numerous materials, and mixtures of materials, may be used as dopants in metal nitride powders, such as germanium (Ge), tin (Sn) and carbon (C) for n-type semiconductor materials, and zinc (Zn), cadmium (Cd), and beryllium (Be) for p-type semiconductor materials. To date, the process has been tested and verified using silicon (Si), magnesium (Mg), and zinc (Zn) as dopants in GaN and AlGaN powders. Analytical tests of the resulting Mg-doped and Si-doped GaN powders display luminescence from 3 to 4 times better than GaN thin films doped with Mg or Si. In addition, the generally recognized superior characteristics of metal nitrides compared to metal sulfides as an EL material indicate that the resulting doped metal nitride powders will display even greater improvements in luminescence over ZnS powders. Moreover, the resulting doped metal nitride powders will have a longer lifetime than metal sulfide powders because the stronger chemical bonds in the nitride compound result in a more stable crystal structure. This is manifested by fewer defects and significantly lower degradation rates in the doped GaN powders synthesized to date.

The preferred embodiment of the present invention is a method that consists essentially of two major steps: (1) formation of a metal-dopant alloy, and (2) nitridation of the metal-dopant alloy with ultra-high purity ammonia in a reactor. A metal-dopant alloy is prepared by placing ultra-high purity metal in a liquid state (e.g., 99.9995 weight %) and the dopant of choice (e.g., Si or Mg) in a stainless steel vessel under a vacuum at temperatures in the range of 200° C. to 1000° C., and mechanically mixing the vessel for several hours to produce a highly homogenous alloy. Nitridation of the resulting metal-dopant alloy to yield a doped metal nitride powder is achieved in a reactor by flowing ultra-high purity ammonia (e.g., 99.9995 weight %) through the reactor under vacuum and at a high temperature for several hours. The process according to the preferred embodiment allows high control of the process parameters, including reactants, products, temperature and pressure.

For the purpose of summarizing the invention, certain aspects, advantages and novel features of the invention have been described above. It is to be understood, however, that not necessarily all such advantages may be achieved in accordance with any particular embodiment of the invention. Thus, the invention may be embodied or carried out in a manner that achieves one or more of the advantages as taught herein, without necessarily achieving all of the other advantages that may be taught or suggested herein.

### BRIEF DESCRIPTION OF THE DRAWINGS

FIG. 1 is a schematic illustration of a mechanical mixer used in the practice of the invention;

FIG. 2 is a schematic illustration of a reactor used in the practice of the invention;

FIG. 3(a) is a SEM micrograph of small hexagonal platelets of magnesium doped GaN powder synthesized in accordance with a preferred method of the present invention;

FIG. 3(b) is a SEM micrograph of large columnar crystals of magnesium doped GaN powder synthesized in accordance with a preferred method of the present invention;

FIG. 4(a) is a room temperature photoluminescence (PL) spectrum of as-synthesized and annealed magnesium doped GaN powder synthesized in accordance with a preferred method of the present invention;

FIG. 4(b) is a liquid helium temperature cathodoluminescence (CL) spectrum of magnesium doped GaN powder synthesized in accordance with a preferred method of the present invention;

FIG. 5(a) is a SEM micrograph of small platelets of silicon doped GaN powder synthesized in accordance with a preferred method of the present invention;

FIG. 5(b) is a SEM micrograph of large columnar crystals of silicon doped GaN powder synthesized in accordance with a preferred method of the present invention;

FIG. 6 is a room temperature PL spectrum of silicon doped GaN powder synthesized in accordance with a preferred method of the present invention; and

FIG. 7 is a room temperature CL spectrum of silicon—magnesium co-doped GaN powder synthesized in accordance with a preferred method of the present invention.

### DETAILED DESCRIPTION

Although certain preferred embodiments and examples of the present invention are discussed below, it will be understood by those skilled in the art that the invention extends beyond the specifically disclosed embodiments to other alternative embodiments of the invention and obvious modifications and equivalents thereof. Thus, it is intended that the scope of the present invention should not be limited by the particular embodiments disclosed herein. For instance, the scope of the invention is not limited by the exact sequence of acts described, nor is it limited to the practice of all of the acts set forth. Other sequences of events or acts, or less than all of the events, or simultaneous occurrences of the events, may be utilized in practicing the method(s) disclosed herein.

### General Description

The preferred method of synthesizing doped metal nitride powder generally includes preparing a metal-dopant alloy using a mechanical mixer, and reacting the resulting metal-dopant alloy with ultra-high purity ammonia (e.g., 99.9995 weight %) in a reactor for several hours at an elevated temperature. The preferred method produces highly luminescent powders with a luminescent efficiency that exceeds by three to four orders of magnitude the efficiency previously seen in other commercially-available GaN powders and GaN thin films.

The method disclosed below is the preferred method for producing doped GaN powders. Due to variations in the physical and chemical characteristics of various dopants, some of the parameters of the process may vary, such as preferred temperatures and reaction times in the process. However, the process consists of the same acts and events. Those skilled in the art will recognize the adjustments in process parameters required to carry out the invention for a particular dopant or mixture of dopants. Furthermore, those skilled in the art will recognize that the same process that is the subject of this invention may be used to dope other Group III metal nitrides known to exhibit useful semiconductor characteristics, including InN, AlN, AlGaN, InGaN, AlInN and AlInGaN materials. This is achieved by adding aluminum, indium or both, either in lieu of or in addition to gallium, to the dopant and mechanically mixing the mixture to produce an alloy. The remaining steps are the same.

### Preferred Method of Producing Doped GaN Powders

A preferred method of producing highly luminescent doped GaN powder is disclosed below, and specific process parameters for the preferred method of producing silicon-doped GaN powder and magnesium-doped GaN powders are given by way of example. The following method is provided by way of illustration only and not by way of limitation. Those of skill in the art will readily recognize a variety of noncritical parameters that could be changed or modified to yield essentially similar results. Further, those skilled in the art will recognize that a variety of dopants and mixture of dopants and a variety of Group III metal nitrides and their ternary and quaternary alloys may be used in the process that is the subject of this invention and that certain adjustments to the process parameters (e.g., temperature, pressure, time) will be required to account for the different physical and chemical characteristics of a particular dopant and nitride. The required adjustments will be known by those skilled in the art.

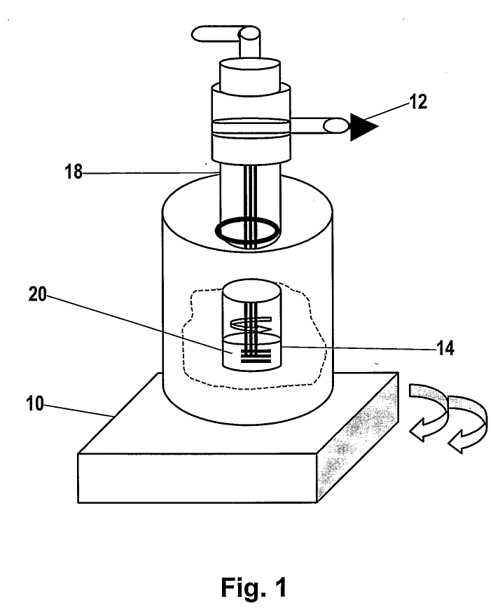

With reference to FIG. 1, in the first step of the process, a highly homogenous gallium-dopant alloy is prepared. Gallium metal is melted and placed in a vessel 14, such as a high-alumina crucible, with small chunks of dopant material. The gallium metal is preferably of a purity ranging between 99.9 weight % and 99.9999 weight %, and most preferably of an ultra-high purity, such as 99.9995 weight %. The dopant chunks are preferably of a purity ranging between 99.9 weight % and 99.9999 weight %, and most preferably of an ultra-high purity such as 99.999 weight %. The vessel 14 containing the gallium metal and dopant chunks is placed in a stainless steel sealed vessel 18 under vacuum 12 (depicted as an arrow in FIG. 1) at an elevated temperature. The sealed vessel 18 is mechanically mixed using a mechanical shaker 10 for several hours to produce a highly-homogenous gallium-dopant alloy 20. The mixing time will vary with the temperature and vacuum used in the process, as well as with the particular dopant and metal nitride used in the process. The resulting gallium-dopant alloy is poured into a vessel 22, such as a commercially available alumina boat.

For preparation of a gallium—magnesium alloy, the preferred process involves placing the sealed vessel 18 under a vacuum of approximately 0.001 Torr, at a temperature ranging between 200° C. to 1000° C., most preferably 500° C., for one or more hours, most preferably for seven hours. For the preparation of gallium—silicon alloy, the preferred process involves placing the sealed vessel 18 under a vacuum of approximately 0.001 Torr, at a temperature ranging between 500° C. to 1000° C., most preferably 700° C., for one or more hours, most preferably 10 hours. This preferred process results in a highly homogenous gallium—magnesium or gallium—silicon alloy. The composition of the alloy can be accurately controlled with the time and temperature of the alloying step, which experimentation shows closely follows the published phase diagrams for binary and ternary alloys. Dopant concentrations ranging from 0.1 at % to 3 at % have been comfortably achieved. Those skilled in the art will recognize that this range can be extended significantly towards higher and lower concentration ranges. Massalski, T. B., Okamoto, H., Subramanian, P. R., Kacprzak, L., Binary Alloy Phase Diagrams, 2, 1822-1823 (1990).

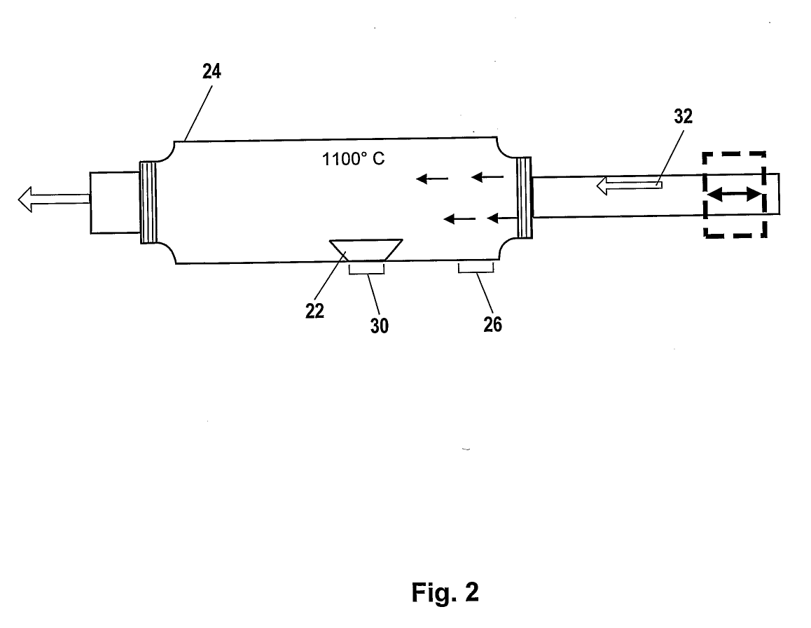

With reference to FIG. 2, the vessel 22 containing the gallium-dopant alloy is placed into a tube reactor 24. The tube reactor may be, for example, a horizontal quartz tube reactor consisting of a fused silica tube (3.5 cm inner diameter and 120 cm length) with stainless steel flanges at both ends, which is introduced into a Lindberg tube furnace (80 cm length) with a maximum operating temperature of 1200° C. The fused silica tube is connected through its flanges with a gas supply system at the entrance and a vacuum system at the exit. An explanation of tube reactors is disclosed in R. Garcia, et. al., “A novel method for the synthesis of sub-microcrystalline wurtzite-type InₓGaₓ₋₁N powders,” Materials Science and Engineering (B): Solid State Materials for Advanced Technology, B90, 7-12 (2002), incorporated herein by reference. Of course, other types of reactors or equivalent devices may be used, as is known in the art.

With further reference to FIG. 2, the tube reactor 24 is tightly closed and evacuated to create a vacuum of approximately 0.001 Torr, while being simultaneously heated in an electric furnace to a temperature ranging between 900° C. and 1200° C., with the vessel 22 located near the entrance 26 of the tube reactor 24 (the location referred to as the “cold zone”).

After approximately one hour, the central portion 30 of the tube reactor 24 (the location referred to as the “hot zone”) reaches a temperature between approximately 1100° C. and 1200° C. The preferred process for producing magnesium-doped GaN powders involves allowing the central portion 30 of the tube reactor 24 to reach, most preferably, approximately 1100° C. The preferred process for producing silicon-doped GaN powders involves allowing the central portion 30 of the tube reactor 24 to reach, most preferably, approximately 1200° C. Once the above conditions are met, the vacuum process is suspended, and ammonia 32 (depicted as an arrow in FIG. 2) is conducted through the tube reactor 24 at a rate of between 200 cm³/min and 1000 cm³/min, and most preferably at approximately 350 cm³/min. The ammonia 32 conducted through the tube reactor 24 is of a purity ranging between 99.99 weight % and 99.9999 weight %, most preferably of an ultra-high purity of 99.9995 weight %.

As steady-state conditions are approached, an alloy-ammonium solution begins to form. After approximately one hour, steady-state conditions are reached. Continuing with reference to FIG. 2, the vessel 22 with the alloy-ammonium solution is moved to the central portion or hot zone 30 of the tube reactor 24 using a magnetic manipulator as is known in the art. The vessel 22 remains in the central portion 30 of the tube reactor 24 for a range between one to twenty hours, most preferably for approximately ten hours. During this time, a solid doped GaN product (e.g., GaN:Mg or GaN:Si) forms in the vessel 22. The vessel 22 is then moved back to the entrance or cold zone 26 of the tube reactor 24 and allowed to cool to room temperature. After the solid product is cooled to room temperature, the vessel 22 is taken out of the reactor 24 and the solid product is ground in a mortar, as is known in the art, fracturing the doped GaN product to produce a powder. The result is a highly-luminescent doped GaN powder of the invention.

The same process may be used to synthesize doped InN, AlN, AlGaN, InGaN, AlInN and AlInGaN powders. This is achieved by melting the metal or metals of choice (In, Al, Ga, and or a combination thereof) and placing the melt in the first vessel 14 along with the dopant chunks. The remaining steps are the same.

### Analytical Results

While the present invention generally covers a process for introducing various dopants into various metal nitrides to produce doped metal nitride powders exhibiting superior luminescent properties, testing and verification of the process that is the subject of this invention have focused to date on the introduction of Si in GaN to produce n-type semiconductor powder, of Mg and Zn in GaN to product p-type semiconductor powder, and of Si and Mg in GaN to produce co-doped semiconductor powder. In addition, AlGaN powders have been successfully doped. The analytical results for these powders are summarized below.

### Magnesium-Doped GaN Powders

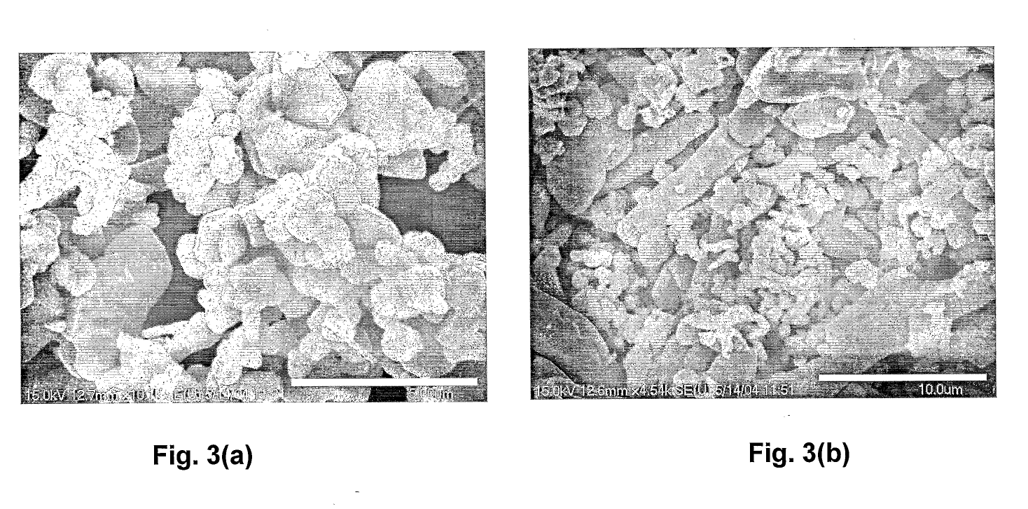

SEM images of the magnesium-doped GaN powder (GaN:Mg) were obtained using a Hitachi S-4700-II field emission scanning electron microscope. The powder is observed to have two predominant types of particles shown in FIGS. 3(a) and 3(b). FIG. 3(a) shows predominantly small hexagonal platelets with a narrow particle size distribution between 1 and 3 micrometers. FIG. 3(b) shows predominantly big columnar crystals between 10 and 20 micrometers long. Other particles with different morphologies were shown to be present in the magnesium-doped GaN powder, but the platelets and columnar crystals were the predominant forms.

An x-ray diffraction analysis of the magnesium-doped GaN powder showed a very well defined hexagonal wurtzite crystalline structure with lattice parameters very similar to those found in pure GaN powder when calculated in PDF card No. 76-0703. There are no other crystalline phases present such as oxides, other nitrides or pure metals, which demonstrates the high crystalline quality and high purity of GaN:Mg powders produced by the present invention.

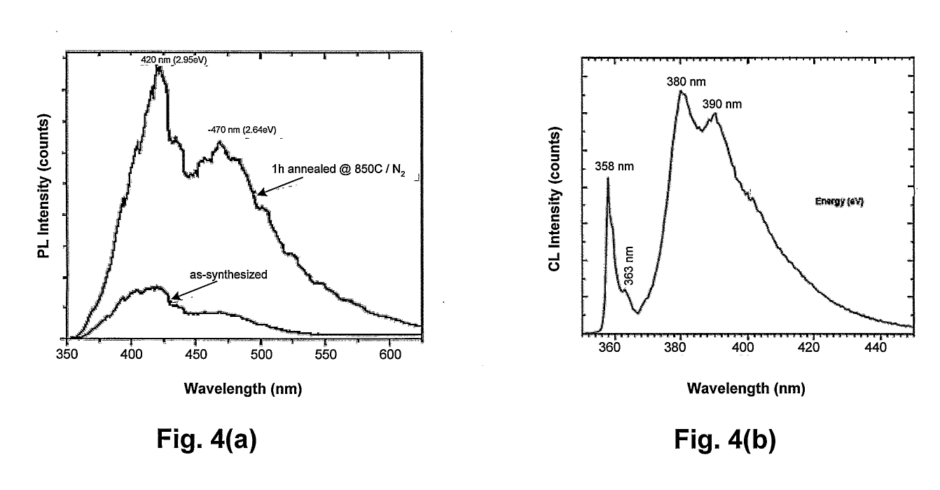

A room temperature photoluminescence (PL) spectrum of as-synthesized and annealed GaN:Mg powders is shown in FIG. 4(a). Both spectra were taken under the same conditions and using the same excitation source, a laser He—Cd (325 nm) with 100 micrometer slit width and 1 order of magnitude filter. FIG. 4(a) illustrates the typical broad emissions of GaN:Mg, one centered at 420 nm (2.95 eV, violet) and the other at 470 nm (2.64 eV, blue). FIG. 4(a) also illustrates that the PL intensity of the GaN:Mg powder is improved by an annealing process.

The GaN:Mg powders were further characterized using cathodoluminescence (CL) spectroscopy, performed at liquid helium temperature in a scanning electron microscope with an acceleration voltage of 5 keV and a beam current of 0.3 nA. The resulting CL spectrum shown in FIG. 4(b) exhibits peaks at 358 nm (3.464 eV), 363 nm (3.416 eV), and a broad peak from 370 to 450 nm. The 358 nm peak is the donor bound exciton peak which is often observed in GaN thin films. The 363 nm peak is often related to stacking faults in GaN. The broad peak from 370 to 450 nm is believed to be the donor acceptor pair band, which has been attributed to recombination between the residual donor and the magnesium acceptor levels. This peak is not present in similar undoped GaN powders, and therefore, is proof that magnesium is incorporated as an acceptor level.

These analytical results illustrate that a high purity magnesium-doped GaN powder has been produced by the present invention. The process is both simple and inexpensive, allowing for bulk production of these powders, which exhibit a luminescent efficiency that greatly exceeds that seen in pure undoped GaN powders and doped GaN thin films. The luminescent efficiency of the magnesium-doped GaN powders will further exceed that seen in ZnS powders due to the superior semiconductor characteristics GaN generally displays over ZnS. At room temperature, the GaN:Mg powder exhibits a bright blue cathodoluminescence emission around 2.94 eV (422 nm) and 2.64 eV (470 nm), which indicates that the material is a good candidate for EL devices.

### Zinc-Doped GaN Powders

GaN powders have also been successfully doped with Zn to produce p-type semiconductor powder. Zinc doping produces emission in the blue-green range, as compared with magnesium doping, which produces emission in the blue range of the spectrum. The reaction that converts gallium—zinc alloy to Zn-doped GaN powder takes less time than any other dopant introduced into GaN powder to date.

### Silicon-Doped GaN Powders

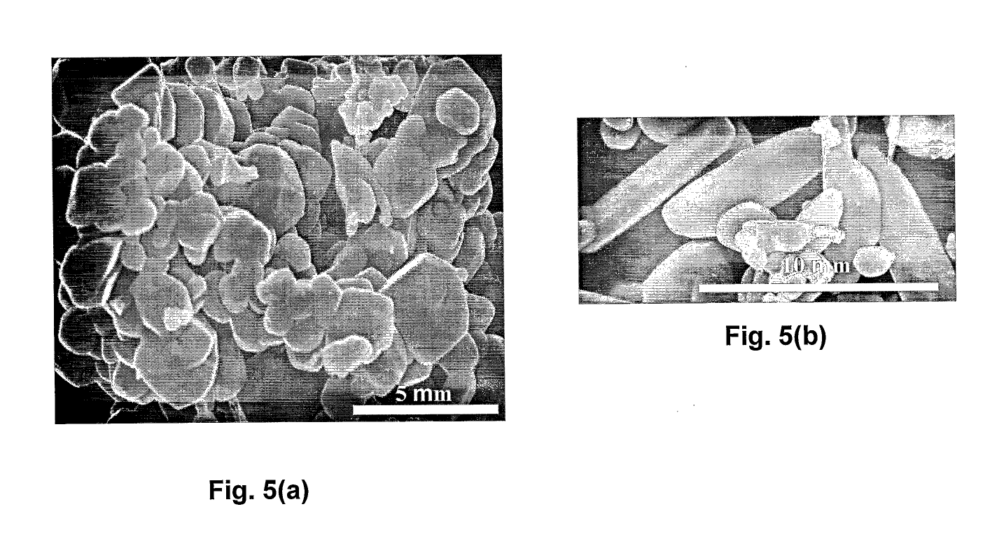

SEM images of the silicon-doped GaN (GaN:Si) powder were obtained using a Hitachi S-4700-II field emission scanning electron microscope. The powder is observed to have two predominant types of particles shown in FIGS. 5(a) and 5(b). FIG. 5(a) shows predominantly small platelets with a narrow particle size distribution between 1 and 3 micrometers. FIG. 5(b) shows predominantly large columnar crystals approximately 10 micrometers long. Other particles with different morphologies were shown to be present in the silicon-doped GaN powder, but the platelets and columnar crystals were the predominant forms.

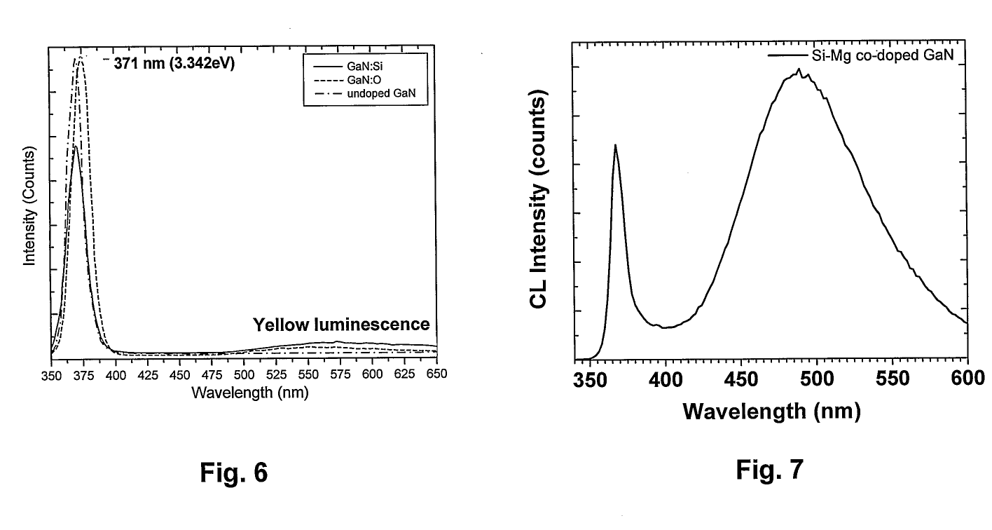

A room temperature PL spectrum shown in FIG. 6 of undoped GaN and GaN:Si powders illustrate that yellow luminescence (YL) is not emitted by the undoped GaN powder. However, YL is emitted by the silicon-doped GaN powders resulting from the present invention.

These analytical results illustrate that a high quality silicon-doped GaN powder has been produced by the present invention. The process is both simple and inexpensive, allowing for bulk production of these powders, which exhibit a luminescent efficiency that greatly exceeds that seen in pure GaN powders and in GaN thin films. Further the luminescent efficiency of the silicon-doped GaN powders should exceed that seen in ZnS powders due to the superior semiconductor characteristics GaN generally displays over ZnS.

### Silicon and Magnesium Co-Doped GaN Powders

We have succeeded in producing powders simultaneously doped with acceptor and donor impurities. In particular, GaN powders co-doped with silicon and magnesium have proved to have interesting properties, most importantly, broad emission characteristics closely resembling a white spectrum. This is shown in the CL spectrum in FIG. 7. The corresponding electroluminescence spectrum has very similar characteristics as the CL and PL spectra.

### Doping InGaN and AlGaN Powders

We have succeeded in producing doped AlGaN powders with aluminum compositions up to the 70% range. In prior art, R. Garcia succeeded in producing high quality InGaN powders. See R. Garcia, et. al., “A novel method for the synthesis of sub-microcrystalline wurtzite-type InₓGaₓ₋₁N powders,” Materials Science and Engineering (B): Solid State Materials for Advanced Technology, B90, 7-12 (2002), incorporated by reference above. Those skilled in the art will recognize that doping of InGaN using the procedures herein should be feasible.

We claim:

1. A method for making doped metal nitride powders comprising the steps of:
forming a metal-dopant alloy, and subjecting the metal-dopant alloy to a temperature between 900° C. and 1200° C. in an ammonia flow to react the ammonia with the metal-dopant alloy to produce a crystalline structure characterized by:
hexagonal platelets having a small distribution in size, and
large columnar micro-crystals having a large distribution in size,
wherein both the platelets and micro-crystals have a well defined wurtzite crystalline structure.

2. The method of claim 1, wherein the metal is gallium.

3. The method of claim 1, wherein the metal is indium.

4. The method of claim 1, wherein the metal is aluminum.

5. The method of claim 1, wherein the metal is a mixture of aluminum and gallium.

6. The method of claim 1, wherein the metal is a mixture of indium and gallium.

7. The method of claim 1, wherein the metal is a mixture of aluminum and indium.

8. The method of claim 1, wherein the metal is a mixture of indium, aluminum, and gallium.

9. The method of claim 1, wherein the dopant is magnesium.

10. The method of claim 1, wherein the dopant is zinc.

11. The method of claim 1, wherein the dopant is silicon.

12. The method of claim 1, wherein the dopant is a mixture of silicon and magnesium.

13. The method of claim 1, wherein the dopant is a mixture of a donor impurity and an acceptor impurity.

14. The method of claim 1, wherein the solid crystalline product is ground in a mortar to produce a powder.

15. The method of claim 14, wherein the powder is subjected to further annealing.

16. The method of claim 1, wherein the metal is of a high purity, greater than about 99 weight %; the dopant chunks are of a high purity, greater than about 99 weight %; and the ammonia is of a high purity, greater than about 99 weight %.

17. The method of claim 1, wherein the metal-dopant alloy is subjected to a vacuum of about 0.001 Torr or greater vacuum.

18. The method of claim 1, wherein the ammonia flow is 200 cm³/min or greater.

19. A method for making doped metal-nitride powders comprising the steps of:
melting a metal;
placing the resulting melt and small chunks of a dopant in a first vessel;
placing the first vessel in a second larger vessel that is sealed, under vacuum and at a temperature between 500° C. and 1000° C.;
mechanically mixing the second vessel for several hours to produce a metal-dopant alloy;
placing the resulting metal-dopant alloy in a third vessel;
placing the third vessel in a cold zone of a reactor;
closing the reactor and evacuating the reactor to create a vacuum;
heating the reactor until a hot zone of the reactor reaches a temperature between about 1100° C. and about 1200° C.;
conducting ammonia through the reactor until steady state conditions are reached;
placing the third vessel in the hot zone of the reactor for one or more hours to produce a solid crystalline structure in the third vessel;
placing the third vessel in the cold zone of the reactor and allowing the solid crystalline structure to cool to room temperature and removing the solid crystalline structure from the reactor.

20. The method of claim 19, wherein the metal is gallium.

21. The method of claim 19, wherein the metal is indium.

22. The method of claim 19, wherein the metal is aluminum.

23. The method of claim 19, wherein the metal is a mixture of aluminum and gallium.

24. The method of claim 19, wherein the metal is a mixture of indium and gallium.

25. The method of claim 19, wherein the metal is a mixture of aluminum and indium.

26. The method of claim 19, wherein the metal is a mixture of indium, aluminum, and gallium.

27. The method of claim 19, wherein the dopant is silicon.

28. The method of claim 19, wherein the dopant is magnesium.

29. The method of claim 19, wherein the dopant is zinc.

30. The method of claim 19, wherein the dopant is a mixture of silicon and magnesium.

31. The method of claim 19, wherein the dopant is a mixture of a donor impurity and an acceptor impurity.

32. The method of claim 19, wherein the solid crystalline product is ground in a mortar to produce a powder.

33. The method of claim 32, wherein the powder is subjected to further annealing.

34. The method of claim 19, wherein the gallium metal is of a high purity, greater than about 99 weight %; the dopant chunks are of a high purity, greater than about 99 weight %; and the ammonia is of a high purity, greater than about 99 weight %.

35. The method of claim 19, wherein the reactor is a horizontal quartz tube reactor.

36. The method of claim 19, wherein the second vessel is made of stainless steel and the second vessel is evacuated to a vacuum of about 0.001 Torr or greater vacuum.

37. The method of claim 19, wherein the reactor is evacuated to a vacuum of about 0.001 Torr or greater vacuum.

38. The method of claim 19, wherein ammonia is conducted through the reactor at a rate of 200 cm³/min or greater.

39. Doped metal nitride powder made by the method of claim 1.
